(19) United States
(12) Patent Application Publication
(10) Pub. No.: US 2025/0111438 A1
(43) Pub. Date: Apr. 3, 2025

(54) METHOD AND SYSTEM FOR SELF-PERPETUATING WEALTH GENERATION AND DISTRIBUTION USING A RECIPROCATING CROWDFUNDING (RCF) METHODOLOGY

(71) Applicant: Anthony Christopher Saint Michael, Milford, OH (US)

(72) Inventor: Anthony Christopher Saint Michael, Milford, OH (US)

(21) Appl. No.: 18/479,156

(22) Filed: Oct. 2, 2023

(51) Int. Cl. G06Q 40/06; G06Q 40/02; G06Q 40/04

(52) U.S. Cl. CPC G06Q 40/06; G06Q 40/02; G06Q 40/04; G06Q 2220/00

(57) ABSTRACT

The disclosure provides a method for self-perpetuating wealth generation and distribution using a reciprocating crowdfunding (RCF) methodology comprising providing an RCF module system that is configured for, generating wealth for a plurality of system participants (SPs) in an RCF cycle, wherein the plurality of system participants are arranged in a single file linear, binary tree, or matrixed tree arrangement. The RCF cycle includes a gifting cycle and a corresponding receiving cycle of equal stages. The wealth is generated by gifting a multiple of X amount to one or more Upline participants of one or more upgrades within the linear, binary tree, or matrixed tree arrangement by each of the system participants according to one or more stages of the gifting cycle and receiving a multiple of X amount from one or more Downline participants of one or more levels within the linear, binary tree, or matrixed tree arrangement by each of the system participants according to one or more stages of the receiving cycle corresponding to the stages of the gifting cycle.

### CROSS-REFERENCE TO RELATED APPLICATION

The present Non-provisional patent application is a continuation-in-part of U.S. Non-provisional application Ser. No. 17/720,105, filed on Apr. 13, 2022, the disclosure all of which is incorporated by reference in its entities.

### TECHNICAL FIELD

The present disclosure relates to a method and system for self-perpetuating wealth generation and distribution, and more particularly a method of wealth generation using a reciprocating crowdfunding (RCF) methodology.

### BACKGROUND

Traditional peer-to-peer equity, gifting, and rewards crowdfunding are well-known and legal means of pursuing the generation and sharing of wealth but contain varied shortcomings and failures.

Additionally, traditional Multi-Level Marketing (MLM) is a well-known and legal means of pursuing the generation and distribution of wealth but likewise contains varied shortcomings and failures, such as over-emphasizing the recruiting of new members due to a difficult and out-moded business model. Furthermore, MLM type marketing generates wealth only for the members on the top of the pyramid-type structure, requiring each downline member to work and recruit new members to generate wealth for the upline before they themselves can earn money. Moreover, the MLM unilevel, binary, trinary, and matrix type methodologies are “static” rather than “dynamic”, creating further varied shortcomings and failures.

### SUMMARY

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present disclosure discloses a method and a computational program for self-perpetuating generation, distribution, regeneration, and redistribution of wealth using an entirely unique and novel reciprocating crowdfunding (RCF) methodology. A first aspect of the present disclosure relates to a computer program product for generation and distribution of wealth. The second aspect is self-perpetuating wealth generation accomplished through a systematic regeneration and redistribution of the initial wealth generation and distribution. The computer program product, according to the first and second aspects, is provided with a tangible computer-readable medium including computer-executable instructions, embedded in a medium, for self-perpetuating wealth generation and distribution using a reciprocating crowdfunding (RCF) methodology. The instructions of the computer program product comprises instructions for providing an RCF module system that is configured for generating wealth for a plurality of system participants (SPs) in an RCF cycle. The plurality of system participants can be arranged in either a single file linear, binary tree, or matrixed tree, hereinafter referred to individually, collectively, and in general as the “Gifting/Receiving” arrangement. The RCF cycle includes a gifting cycle and a corresponding receiving cycle of equal stages. The methodology of wealth transfer can be accomplished by smart contracts or direct trading of assets accomplished by the computer readable program product.

The wealth, using the computer readable program product of the first aspect is generated by gifting a multiple of X amount to one or more Upline participants of one or more upgrades within the Gifting/Receiving arrangement by each of the system participants according to one or more stages of the gifting cycle and receiving a multiple of X amount from one or more Downline participants of one or more levels within the Gifting/Receiving arrangement by each of the system participants according to one or more stages of the receiving cycle corresponding to the stages of the gifting cycle. The gifting cycle and the receiving cycle each may have one or more corresponding stages. Each of the one or more upgrades within the linear, binary, or matrixed tree Gifting/Receiving arrangement corresponds to the stage of the gifting cycle. Each of the one or more levels within the Gifting/Receiving arrangement corresponds to the stage of the receiving cycle corresponding to the one relating stage of the gifting cycle.

The X may be any amount in money measured in any varied fiat currency such as consideration amount of dollars or euros, or measured in any other particular monetary form or quantifier.

The X may be a product of any type of fungible or non-fungible tokens, securities, commodities, vouchers, gift cards, products, or services.

Further, the RCF module, at a joining of the system participant, may be configured to receive a joining donation of X consideration amount from the system participant, gift the X consideration amount as a donation to a first upline participant of a first upgrade of the Gifting/Receiving arrangement, receive, for the system participant, the 2X consideration amount as the donation from two downline participants of a first level of the Gifting/Receiving arrangement, gift another X consideration amount as a donation to a second upline participant of a second update of the Gifting/Receiving arrangement, and generate the X consideration amount for the system participant as a net consideration.

Further, the RCF module may be configured to receive the X consideration as a donation from the system participant, gift the received X consideration amount to the second upline participant of the second upgrade of the Gifting/Receiving arrangement, receive, for the system participant, the 4X consideration amount as donation from four downline participants of a second level of the Gifting/Receiving arrangement, gift the 2X consideration amount as a donation to a third upline participant of a third upgrade of the Gifting/Receiving arrangement, and generate the 2X consideration amount for the system participant as a net consideration.

Further, the RCF module may be configured to receive the 2X consideration amount as a donation from the system participant, gift the 2X consideration amount as a donation to a third upline participant of a third upgrade of the Gifting/Receiving arrangement, receive, for the system participant, the 16X consideration amount as the donation from eight downline participants of a third level of the Gifting/Receiving arrangement, gift an 8X consideration amount as a donation to a fourth upline participant of a fourth upgrade of the Gifting/Receiving arrangement and generate the 8X consideration amount for the system participant as a net consideration.

Further, the RCF module may be configured to receive the 8X consideration amount as a donation from the system participant, gift the 8X consideration amount as a donation to a fourth upline participant of a fourth upgrade of the Gifting/Receiving arrangement, receive, for the system participant, the 128X consideration amount as a donation from 16 downline participants of a fourth level of the Gifting/Receiving arrangement, gift a 12X consideration amount as a donation to a fifth upline participant of a fifth upgrade of the Gifting/Receiving arrangement, and generate the 116X consideration amount for the system participant as a net consideration.

Further, the RCF module may be configured to receive the 12X consideration amount as a donation from the system participant, gift the 12X consideration amount as a donation to a fifth upline participant of a fifth upgrade of the Gifting/Receiving arrangement, receive, for the system participant, the 384X consideration amount as a donation from 32 downline participants of a fifth level of the Gifting/Receiving arrangement, and receive, by the RCF module, 383X consideration amount, minus 1X as re-entry gifting cost for a next RCF cycle.

The RCF module may be further configured to generate 130X consideration amount for the system participant (SP) as a total net consideration after the RCF cycle. Upon completion of any various X consideration level of 2 to 5 (or more) the system participant (SP) completes a full cycle and exits the RCF module.

The RCF module may be further configured to generate any varied consideration amount for the system participant as a total net consideration after the RCF cycle to provide for system fees and underwriting. A full cycle is the completion of the entire number of levels of Gifting/Receiving arrangement donations and receptions of gifting consideration(s) cycles.

The RCF module may be further configured with an auto re-entry feature that recycles each system participant (SP) back into the RCF to begin the gifting/receiving process all over again, to the benefit of the system participants themselves, to the benefit of the upline participants, and to the benefit of the entirety of the system itself through a unique form of self-perpetuation.

Hence, the RCF module and the present system, contrary to traditional MLM marketing, does not require the system participant (SP) to continuously hunt for new recruits for system-perpetuation or otherwise. Instead, it generates wealth for any system participant (SP) in a cycle having from 2 to 5 (or more) levels of upline and 2 to 5 (or more) correlated levels of downline. Further, the system, as compared to MLM, does not necessarily include any goods or services or require the mandatory purchase of goods or services associated with the MLM marketing methodology to generate wealth for the upline.

Furthermore, whereas the MLM methodology determines a static placement of a participant in a unilevel, binary, trinary, or matrix, altered only by a known compression methodology but retaining its static nature, the RCF System is “dynamic” vs. that static MLM structural methodology. This is achieved by virtue of an “auto re-entry” feature initiated after the system participant (SP) completes a full cycle and exits the RCF module, rather than statically remaining within the unilevel, binary, trinary, or matrix construct.

Therefore, the present system and the RCF module is a completely different methodology than traditional MLM marketing and should not be considered as one. Even the RCF usage of a matrixed-type methodology is a unique adaptation that anyone versed in the industry would understand and acknowledge as essentially unique for all the foregoing reasons. The functionality, then, of the RCF module generating wealth for any member regardless of the member's level within the arrangement by using the RCF's internal multiple-level cycles methodology, in combination with or apart from the auto re-entry feature sets it apart from MLM.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

Various objects, features, aspects and advantages of the inventive subject matter will become more apparent from the following detailed description of preferred embodiments, along with the accompanying drawing figures in which like numerals represent like components.

FIG. 1 is a block diagram depicting a process flow having an RCF module and other wealth generation and wealth management modules, according to the first aspect of the present disclosure.

FIG. 2 is a detailed block diagram depicting a process flow of FIG. 1, according to an embodiment of the present disclosure.

FIG. 3A is a flow diagram of wealth generation and distribution using a reciprocating crowdfunding (RCF) module and methodology, according to an embodiment of the present disclosure.

FIG. 3B is a tubular binary, matrix flow diagram of wealth generation and distribution using a reciprocating crowdfunding (RCF) module and methodology, according to an embodiment of the present disclosure.

FIG. 3C illustrates a linear version of a flow diagram of wealth generation and distribution using a reciprocating crowdfunding (RCF) module and methodology, according to an embodiment of the present disclosure.

FIG. 3D illustrates method steps of wealth generation from system participants arranged in a linear, binary, or matrixed tree arrangement.

FIG. 3E illustrates method steps of wealth generation from system participants arranged in a linear, binary, or matrixed tree arrangement.

FIG. 4 illustrates auto re-entrance into the RCF cycle after the completion of all levels of the RCF cycle, according to an embodiment of the present disclosure.

### DETAILED DESCRIPTION

In the following description, numerous specific details are set forth in order to provide a thorough understanding of the embodiments of the present invention. It will be apparent to one skilled in the art that embodiments of the present invention may be practiced without some of these specific details or with various modifications of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware and or by human operations.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc, read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic for the necessary performance of the invention.

As used in the description herein and throughout the claims that follow, the meaning of “a”, “an”, and “the” includes plural reference unless the context clearly dictates otherwise. Also, as used in the description herein, the meaning of “in” includes “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and willfully convey the scope of the invention to those ordinarily skilled in the art. Moreover, all the statements herein reciting embodiments of the invention, as well as specific examples thereof, are intended to encompass both structural and functional equivalent thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

The disclosure provides a method and system that uses a novel form of crowdfunding which is reciprocating, which means the participants share in both “donating” and being “donated to” through the monetary mechanism of crowdfunding. In this case, crowdfunding is modified to be reciprocating through a known 2×5 matrix methodology that is sometimes used in multi-level marketing. According to the present disclosure, the donator(s) or giver(s) alternately become the donatee(s) or recipient(s), while the donatee(s) alternately become the donator(s), all taking place concurrently and synchronously. This provides an exceptional incentive for individuals to “donate” or “gift”, which is an incentive that is lacking in typical Crowdfunding and holds it back. The donations, in this case, are monetary, but can also be goods and services.

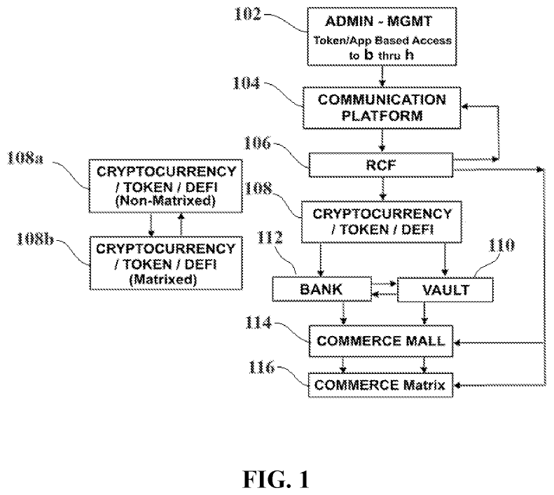

FIG. 1 is a block diagram depicting a process flow having an RCF module and other wealth generation modules, according to the first aspect of the present disclosure.

Referring to FIG. 1, the system includes a plurality of wealth generation and wealth management modules interconnected with other such modules in order to generate a wealth for the system participant users, according to the present aspect. The system comprises a computer program product stored within the tangible computer-readable medium that includes computer-readable instructions. The instructions when executed by the computer processor generate, distribute, regenerate, and redistribute wealth for the system participants (SPs).

According to one embodiment, the system may be a computer-implemented system, computer program product, or a web-based application that comprises an admin management module 102, a communication platform 104, reciprocating crowdfunding (RCF) module 106, integrated Cryptocurrency/tokens/defi 108, a vault module 110, an integrated banking platform 112, an integrated commercial mall platform 114, and an integrated commerce matrix 116.

The admin management module 102 is configured to enable a user or a system participant (SP) to access all the other modules of the system such as participate in an RCF cycle and participate in other modules of the system. Further, the admin management module 102 is configured to control the other modules of the system.

According to one embodiment, the admin management module 102 is configured to provide the platform for the system participants to register within the system using the personnel user credentials. The personnel user credentials may be a name, contact details, and email address. The admin management module 102 may also require bank account details or digital account details of the system participant such as a centralized or decentralized wallet to hold the tokens, cryptocurrency, NTFs, or DeFi.

The communication module or the communication platform 104 is configured to enable the System Participants (SPs) to communicate with each other over platform 104. The system arranges the SPs in a single file linear, binary tree, or matrixed tree arrangement.

According to one embodiment, the communication module 104 may enable SPs to communicate with varying degrees of communication capabilities depending on the qualification, achievement, or need of the System Participant (SP). For instance, the communication platform 104 may enable the SP on a high level within the system arrangement with additional access compared to the downline within the system arrangement. For instance, the SPs at a higher level may mark their communication as confidential which the system makes un-shareable to anyone outside the particular downline or unqualified individuals present within the downline of the linear, binary, or matrixed tree arrangement.

In some embodiment, the SP may also mark the communication as global enabling the system to share the communication or message throughout the system arrangement beyond the limit of the specific downline.

Further, the system provides the RCF module 106 which is configured to generate wealth for the plurality of SPs. The RCF module is configured to generate wealth for the system participants in RCF cycles. The RCF cycles include gifting cycles and corresponding receiving cycles. The wealth may include money in the form of fiat currency or cryptocurrency, stocks, bonds, or other negotiable or non-negotiable financial instruments, fungible and non-fungible tokens, commodities, products, or services. The wealth may be in the form of system specific cryptocurrency, token, DeFi, smart contracts, etc., as proposed in 108, 108a and 108b.

The vault module 110 of the present system is provided for deposit and storage of the wealth generated by the RCF module for the SPs. The admin module 102 and all submodules, or access to, are created by the system and associated with the respective SP at the time of the registration of the SP. The associated vault module 110 works as a saving account to hold the cryptocurrency or any other form of wealth.

In one embodiment, the vault module 110 of the system is provided for the accumulation and compounding of the wealth generated by the system or the RCF module 106 for the benefits of the system participants (SPs) registered with the system.

Further, the integrated banking platform 112 is provided by the system to work in tandem with the vault module 110. The integrated banking platform 112 is configured to enable the funds or wealth placed within the vault module 110 to be utilized later by the SPs.

In one embodiment, the integrated banking platform 112 may be provided for the SPs to attain a loan against the respective vault module 110 of the system participant making the vault module 110 collateral for the loan. The loan may be collateralized against the vault module 110 savings of the SPs.

The system, according to the present aspect, further includes the integrated commerce mall platform 114 provided for external retail commerce and service transactional purposes, and the integrated commerce matrix 116 that is provided for retail commerce purposes and utilizes a matrix of monetary distribution and redistribution methodology, both according to traditional linear, binary, or matrixed methodologies, or the RCF methodology.

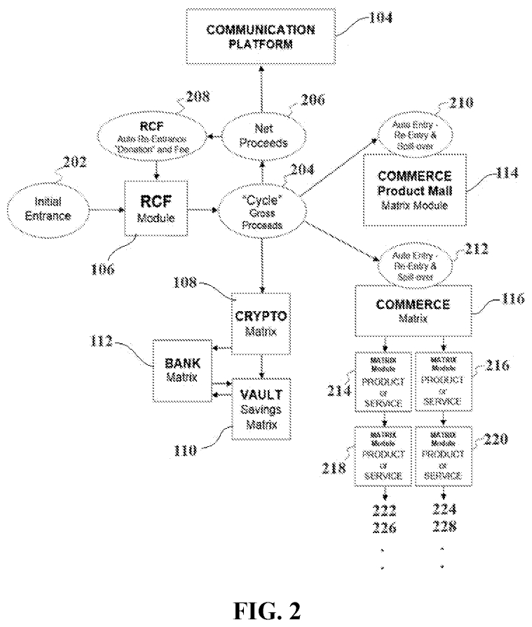

FIG. 2 is a detailed block diagram depicting a process flow of FIG. 1, according to an embodiment of the present disclosure.

Referring to FIG. 2, the computer-implemented system provides the RCF module 106 for self-perpetuating wealth generation and distribution using a reciprocating crowdfunding (RCF) methodology. The RFC module 106 is configured to generate a wealth for a plurality of system participants (SPs) in an RCF cycle. The RCF module 106 provides the SPs an initial entrance 202 by gifting or donating a certain consideration amount and to participate into the reciprocating crowdfunding cycle, hereafter referred as RCF cycle. The methodology of wealth transfer can be accomplished by smart contracts or direct trading of assets accomplished by the computer readable program product.

The RCF module 106 arranges the system participants in a single file linear, binary tree, or matrixed tree arrangement. Further, after initial entrance 202 of the system participant by donating the pre-set consideration amount, the SP auto-progresses through the RCF module. The RCF module includes both a gifting cycle in which the system participate gifts or donates a consideration to the upline system participants, and in a receiving cycle in which the system participant receives the consideration amount from the downline system participants within the tree arrangement. After completion of each RCF cycle, the RCF module 106 generates a cycle gross proceeds (204) for each system participant. In one embodiment, the RCF module 106 may generate multiples of initial donations made by the system participant at initial entrance 202. In one embodiment, the RCF module 106 may generate anywhere between 2× and 130× times consideration, or more, of the initial amount that is gifted or donated by the SP.

The system, from the gross proceeds 204 generated after the RCF cycle, redirects a certain portion into a crypto matrix 108, and a certain portion into a commerce matrix 116 for auto entry, re-entry, or spillover 212. Further, the system redirects a certain portion of the gross proceeds 204 into the commerce product mall 114 for auto entry, re-entry, and spillover 210. Spillover is a term and methodology widely known and used in multi-level marketing.

After re-direction of certain portions or percentages of the RCF generated wealth into a crypto matrix 108, commerce product mall 114, and the commerce matrix 116, the system generates a net proceed 206 for the SP after one RCF cycle. Further, to enter the next RCF cycle, the RCF module 106 requires an RCF auto re-entrance donation 208 from the net proceeds 206 of the SPs. Again, in the next RCF cycle, the RCF module 106 generates wealth in the form of cycle gross proceeds 204 for the SP. In one embodiment, the system may include multiple matrix modules (214, 216, 218, 220, . . . ) within the commerce matrix 116.

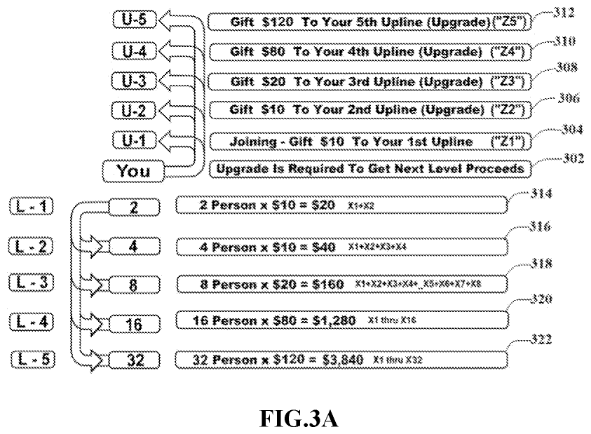

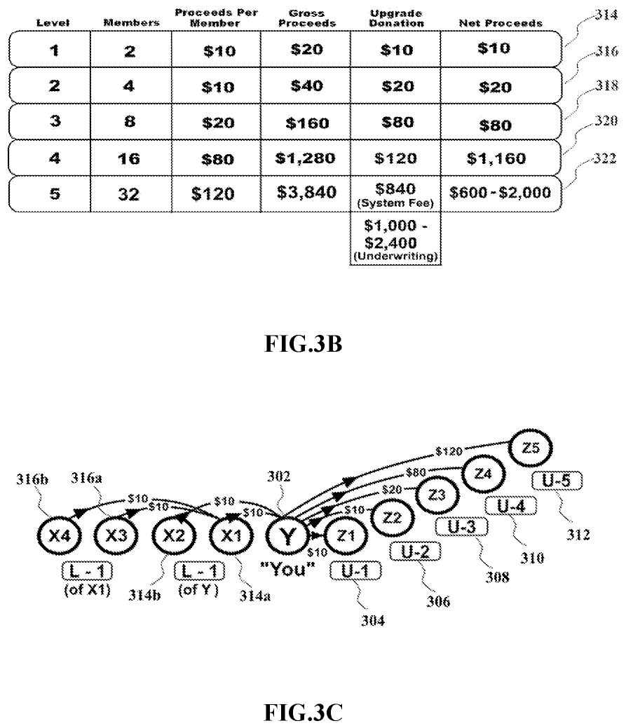

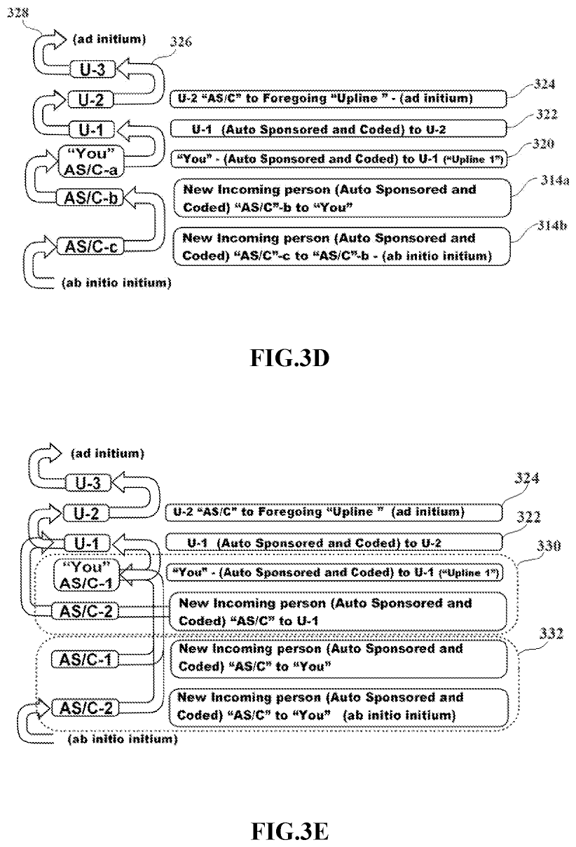

FIG. 3A is a flow diagram of a wealth generation using a reciprocating crowdfunding (RCF) module and methodology, according to an embodiment of the present disclosure.

Referring to FIG. 3A, the RCF module 106, to initiate the RCF cycle of any system participant, requests to receive a joining consideration from the system participant (You), at step 302. For example, the RCF module receives $10 from the system participant (You) as a joining fee or donation.

Further, the RCF module 106 gifts the received joining consideration from the system participant (You) to the first upline participant, at step 304. For example, the RCF module gifts the received $10 from the system participant (You) to the first upline participant.

Successively, the RCF module 106 receives the consideration as a donation or joining gift from the 2 first downline participants for the system participant (You), at step 314. For example, the RCF module 106, may receive $10 as a joining gift from each of the 2 of the first downline participants of the system participant (You). Thus, making a net proceed of $10 for the system participant (You) at joining.

Further, the RCF module 106 requires the system participant (You) to upgrade the level to a second level by again donating the same consideration amount to the second upline participant, at step 306. For example, the RCF module 106 requires the system participant (You) to again donate the same $10 as a consideration to the second upline participant within the linear, binary, or matrixed (hereinafter “Gifting/Receiving”) tree arrangement.

Successively, the RCF module receives the consideration as a donation or gift from the 4 of second downline participants for the system participant (You), at step 316. For example, the RCF module receives $10 amount as a gift from each of the 4 of the second downline participants of the system participant (You). Thus, making a net proceed of $30 for the system participant (You) at the second level.

Further, the RCF module 106 requires the system participant (You) to upgrade the level to a third level by donating the double consideration amount to the third upline participant, at step 308. For example, the RCF module 106 requires the system participant (You) to donate an amount of $20 as a consideration to a third upline participant within the Gifting/Receiving arrangement.

Successively, the RCF module receives the consideration as a donation or gift from the 8 third downline participants for the system participant (You), at step 318. For example, the RCF module receives $20 as a gift from each of the 8 of the third downline participants of the system participant (You). Thus, making a net proceed of $140 amount for the system participant at the third level.

Further, the RCF module 106 requires the system participant (You) to upgrade the level to a fourth level by donating the eight time the initial consideration amount to the fourth upline participant, at step 310. For example, the RCF module 106 requires the system participant (You) to donate an amount of $80 as a consideration to a fourth upline participant within the Gifting/Receiving arrangement.

Successively, the RCF module receives the consideration as a donation or gift from the 16 fourth downline participants for the system participant (You), at step 320. For example, the RCF module receives $80 as a gift from each of the 16 of the fourth downline participants of the system participant (You). Thus, making a net proceed of $1200 amount for the system participant at the fourth level.

Further, the RCF module 106 requires the system participant (You) to upgrade the level to a fifth level by donating the twelve time the initial consideration amount to the fourth fifth participant, at step 312. For example, the RCF module 106 requires the system participant (You) to donate an amount of $120 as a consideration to a fourth upline participant within the “Gifting/Receiving” arrangement.

Successively, the RCF module receives the consideration as a donation or gift from the 32 fifth downline participants for the system participant (You), at step 322. For example, the RCF module receives $120 as a gift from each of the 32 of the fifth downline participants of the system participant (You), thus, making a net proceed of $3720 amount for the system participant at the fifth level.

In one embodiment, the RCF module 106 secures a certain consideration amount from the total net proceed of the system participant as a system fee. Further, the RCF module 106 re-directs a certain amount from the total net proceeds for re-entry of the system participant into the RCF cycle. Further, the RCF module re-directs or secures certain portion of the total net proceeds as an underwriting.

FIG. 3B is a tubular flow diagram of a linear, binary, or matrixed wealth generation and distribution using a reciprocating crowdfunding (RCF) module 106 and methodology, according to an embodiment of the present disclosure.

Referring to FIG. 3B, the RCF module 106 at a first level generates $20 from the 2 members present as a first downline to the SP where each of the 2 first downline member gifts $10 to the SP making the gross proceed of the level one as $20. Further, the RCF module 106 requests an upgrade donation of $10 from the SP for the second level, making the net proceed for the first level to $10 for the SP.

Further, the RCF module 106, in second level, generates $40 as a gross proceed from the 4 members present as a second downline to the SP, where each of the 4 second downline member gifts $10 to the SP making the gross proceed of the second level as $40. Successively, the RCF module 106 requests an upgrade donation of $20 from the SP to enter the third level, thus making the net proceed for the second level to $20 for the SP.

Further, the RCF module 106, in third level, generates $160 as a gross proceed from the 8 members present as a third downline to the SP, where each of the 8 third downline member gifts $20 to the SP making the gross proceed of the third level to $160. Successively, the RCF module 106 requests an upgrade donation of $80 from the SP to enter the fourth level, thus making the net proceed for the third level to $80 for the SP.

Further, the RCF module 106, in fourth level, generates $1280 as a gross proceed from the 16 members present as a fourth downline to the SP, where each of the 16 fourth downline member gifts $80 to the SP making the gross proceed of the fourth level to $1280. Successively, the RCF module 106 requests an upgrade donation of $120 from the SP to enter the fifth level, thus making the net proceed for the fourth level to $1160 for the SP.

Further, the RCF module 106, in fifth level, generates $3840 as a gross proceed from the 32 members present as a fifth downline to the SP, where each of the 32 fifth downline member gifts $120 to the SP making the gross proceed of the fifth level to $3840. Successively, the RCF module 106 secures the system fee of $840 and re-directs anything from $1000 to $2400 as an underwriting, making the net proceeds of the fifth level to $600-$2000.

FIG. 3C illustrates a version of a linear, binary, or matrixed flow diagram or a wealth generation using a reciprocating crowdfunding (RCF) module 106 and methodology, according to an embodiment of the present disclosure.

FIG. 3D illustrates the method steps of wealth generation from system participants arranged in a linear, binary, or matrixed tree arrangement requiring Sponsoring and Coding for qualifying to receive gift money, products, or services.

Referring to FIG. 3D, when the system participant (You) enters the RCF cycle, the RCF module 106 auto-sponsors and codes 320 the SP (You) to the upline participant U−1. Simultaneously, the RCF module 106 auto-sponsors and codes 322 U−1 to U2, and auto sponsors and codes U−2 to U−3.

Further, the RCF module 106 auto-sponsors and codes 314a a new incoming participant as the first downline to the SP (You), and auto sponsors and codes 314b to additional new incoming participant as a downline to the first downline of the SP. Using this method, the RCF module 106 continuously completes the RCF cycles for each of the upline participants and adds new downline participants.

FIG. 3E illustrates the method steps at the second level of wealth generation from SPs arranged in a linear, binary, or matrix tree arrangement.

Referring to FIG. 3E, the RCF module 106 arranges the SPs in a binary tree arrangement. For instance, the RCF module auto-sponsors and codes 330 the SP (You) and another SP as a downline to the SP U−1. Further, the RCF module 106 arranges new participants entering into the RCF cycle and auto-sponsors and codes 332 them as a downline to the system participant (You). Similarly, the RCF module auto-sponsors and codes 322 U−1 to U−2, and U−2 to U−3, etc.

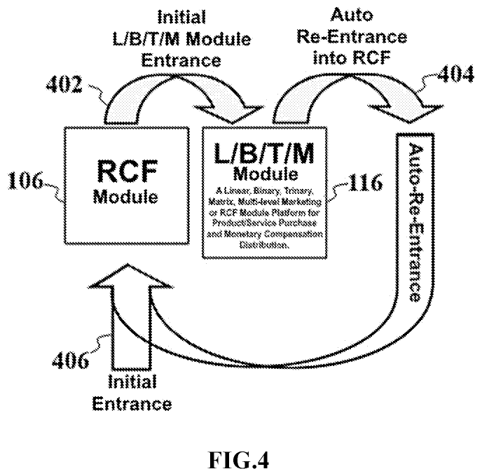

FIG. 4 illustrates auto re-entrance into the RCF cycle after the completion of all levels of the RCF cycle, according to an embodiment of the present disclosure.

Referring to FIG. 4, the RCF module 106 after completion of the RCF cycle for the SP and generation of the net proceed from the cycle, enters 402 the SP into L/B/T/M (Linear, Binary Trinary, or Matrix) module 116, wherein the L/B/T/M module 116 is a linear, binary, trinary, or a matrix platform. The L/B/T/M module 116 is configured for product and service purchase providing monetary compensation distribution thereby, similar to affiliate and multi-level marketing type methodologies.

Further, the system auto redirects the SPs and auto re-enter into the RCF cycle 404 within the RCF module 106 through the initial entrance 406. Within the RCF cycle, the RCF module again generates wealth for the SPs at different levels. For instance, the RCF cycle may have five levels or stages for gifting/donation and generation. In another embodiment, the RCF cycle may have any other number of levels or stages for the donation and reception of the wealth for the SP.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

Similarly, structures and functionality presented as a single component may be implemented as separate components. These and other variations, modifications, additions, and improvements fall within the scope of the subject matter herein. In addition, the term “each” used in the specification does not imply that every or all elements in a group need to fit the description associated with the term “each”. For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that are issued on an application based hereon. Accordingly, the disclosure of the embodiments is intended to be illustrative, but not limiting, of the scope of the patent rights.

1. A computed program product comprising a tangible computer-readable medium including computer-executable instructions, embedded in the medium, for self-perpetuating wealth generation and distribution using a reciprocating crowdfunding (RCF) methodology, the instructions comprising instructions for:
providing an RCF module system that is configured for,
generating wealth, wherein the wealth may be in the form of money, securities, cryptocurrency, fungible and non-fungible tokens, commodities, products, or services, for a plurality of system participants (SPs) in an RCF cycle, wherein the plurality of system participants are arranged in a single file linear, binary tree, or matrixed tree arrangement, wherein the RCF cycle includes a gifting cycle and a corresponding receiving cycle of equal stages, wherein the wealth is generated by
gifting a multiple of X amount to one or more Upline participants of one or more upgrades within the linear, binary tree, or matrix tree arrangement by each of the system participants according to one or more stages of the gifting cycle; and
receiving a multiple of X amount from one or more Downline participants of one or more levels within the linear, binary tree, or matrix tree arrangement by each of the system participants according to one or more stages of the receiving cycle corresponding to the stages of the gifting cycle.

2. The computer program product of claim 1, wherein the system utilizes smart contracts as a means of exchange.

3. The computer program product of claim 1, wherein the X may be any amount in money such as a fiat currency, cryptocurrency, fungible or non-fungible tokens, other forms of DeFi, securities, commodities, vouchers, gift cards, products, or services.

4. The computer program product of claim 1, wherein the X may be a product of any type of token, currency, any amount measured in any varied fiat currency such as consideration amount of dollars or euros, or measured in any other particular monetary form or quantifier.

5. The computer program product of claim 1, wherein the gifting cycle and the receiving cycle each may have one or more corresponding stages.

6. The computer program product of claim 1, wherein each of the one or more upgrades within the linear, binary tree, or matrix tree arrangement corresponds to the stage of the gifting cycle.

7. The computer program product of claim 1, wherein each of the one or more levels within the linear, binary tree, or matrix tree arrangement corresponds to the stage of the receiving cycle corresponding to the one relating stage of the gifting cycle.

8. The computer program product of claim 1, wherein at a joining of the system participant, the RCF module may
receive a joining donation of X consideration amount from the system participant;
gift the X consideration amount as a donation to a first upline participant of a first upgrade of the linear, binary tree, or matrix tree arrangement;
receive, for the system participant, the 2X consideration amount as the donation from two downline participants of a first level of the linear, binary tree, or matrix tree arrangement;
gift another X consideration amount as a donation to a second upline participant of a second update of the linear, binary tree, or matrix tree arrangement; and
generate the X consideration amount for the system participant as a net consideration.

9. The computer program product of claim 8, wherein the RCF module may further
receive the X consideration as a donation from the system participant;
gift the received X consideration amount to the second upline participant of the second upgrade of the linear, binary tree, or matrix tree arrangement;
receive, for the system participant, the 4X consideration amount as donation from four downline participants of a second level of the linear, binary tree, or matrix tree arrangement;
gift the 2X consideration amount as a donation to a third upline participant of a third upgrade of the linear, binary tree, or matrix tree arrangement; and
generate the 2X consideration amount for the system participant as a net consideration.

10. The computer program product of claim 8, wherein the RCF module may further
receive the 2X consideration amount as a donation from the system participant;
gift the 2X consideration amount as a donation to a third upline participant of a third upgrade of the linear, binary tree, or matrix tree arrangement;
receive, for the system participant, the 16X consideration amount as the donation from eight downline participants of a third level of the linear, binary tree, or matrix tree arrangement;
gift an 8X consideration amount as a donation to a fourth upline participant of a fourth upgrade of the linear, binary tree, or matrix tree arrangement; and
generate the 8X consideration amount for the system participant as a net consideration.

11. The computer program product of claim 10, wherein the RCF module may further
receive the 8X consideration amount as a donation from the system participant;
gift the 8X consideration amount as a donation to a fourth upline participant of a fourth upgrade of the linear, binary tree, or matrix tree arrangement;
receive, for the system participant, the 128X consideration amount as donation from 16 downline participants of a fourth level of the linear, binary tree, or matrix tree arrangement.
gift a 12X consideration amount as donation to a fifth upline participant of a fifth upgrade of the linear, binary tree, or matrix tree arrangement; and
generate the 116X consideration amount for the system participant as a net consideration.

12. The computer program product of claim 11, wherein the RCF module may further
receive the 12X consideration amount as a donation from the system participant;
gift the 12X consideration amount as a donation to a fifth upline participant of a fifth upgrade of the linear, binary tree, or matrix tree arrangement;
receive, for the system participant, the 384X consideration amount as donation from 32 downline participants of a fifth level of the linear, binary tree, or matrix tree arrangement; and
receive, by the RCF module, 381X consideration amount as re-entry cost for a next RCF cycle.

13. The computer program product of claim 12, wherein the RCF module generates 130X consideration amount for the system participant as a total net consideration after the RCF cycle.

14. The computer program product of claim 13, wherein the RCF module may direct a certain percentage from the total net consideration into a saving for the corresponding system participant.

15. The computer program product of claim 13, wherein the RCF module may direct a certain percentage from the total net consideration into a digital currency.

16. The computer program product of claim 13, wherein the RCF module may direct a certain percentage from the total net consideration into a pre-purchased gift cards.

17. The computer program product of claim 13, wherein the RCF module may direct a certain percentage from the total net consideration into a varied matrix.

18. The computer program product of claim 17, wherein the varied matrix may include cryptocurrency, non-fungible and fungible tokens, vouchers, and gift cards.

19. The computer program product of claim 17, wherein the varied matrix may include services such as utilities, telecom, legal and accounting, investments, and securities such as stocks, bonds, and commodities.

20. The computer program product of claim 17, wherein the varied matrix may include products such as food and grocery, wellness, skincare, children and elderly products, varied insurance products, travel and vacation-related products, and any other products of a consumer nature.

21. The computer program product of claim 1, wherein the wealth may be in the form of money, securities, cryptocurrency, fungible and non-fungible tokens, commodities, products, or services.
